(19) United States
(12) Patent Application Publication
(10) Pub. No.: US 2006/0218771 A1
(43) Pub. Date: Oct. 5, 2006

(54) Electrical Wire Stripping Method

(76) Inventors: Yuji Ikeda, Kanagawa (JP); Koji Imai, Kanagawa (JP)

Correspondence Address: BARLEY SNYDER, LLC, 1000 WESTLAKES DRIVE, SUITE 275, BERWYN, PA, 19312, US

(21) Appl. No.: 11/277,413

(22) Filed: Mar. 24, 2006

(30) Foreign Application Priority Data
Mar. 30, 2005 (JP) 2005-98400

(51) Int. Cl. B23P 23/00

(52) U.S. Cl. 29/564.4

(57) ABSTRACT

A method for stripping an electrical comprises the steps of: positioning the seal on the electrical wire in a position removed a specified distance in an axial direction from a front-end surface of the electrical wire; cutting a cover of the electrical wire by pressing cutting blades against the cover of the electrical wire between the seal and the front-end surface of the electrical wire; removing a cut portion of the cover by moving the cutting blades toward the front-end surface; cutting a core wire of the electrical wire by pressing the cutting blades against the core wire of the electrical wire between the seal and the front-end surface of the electrical wire; and moving the seal in the axial direction toward the front-end surface of the electrical wire to position the seal in the vicinity of a front-end surface of a remainder of the cover.

### FIELD OF THE INVENTION

The invention relates to a method for stripping an electrical wire, and more particularly, to a method of stripping a cover from an electrical wire that has a seal attached thereto.

### BACKGROUND OF THE INVENTION

Waterproof connectors used in the automotive field and the like typically comprise metal contacts that are crimped to end portions of electrical wires. A cover of the electrical wire is stripped at the end portion thereof prior to attachment of the contact. The end portions of the electrical wires are additionally provided with a seal.

A known method for stripping an end portion of a cover from an electrical wire having a seal attached thereto is shown in FIGS. 13A-13C (see JP2002-50432A). As shown in FIG. 13A, an electrical wire W is provided with a seal 100. The electrical wire W includes a core wire W1 and a cover W2. The seal 100 is attached to one end portion of the electrical wire W and consists of a waterproofing member 101 and a cutaway member 102. The seal 100 is positioned on the electrical wire W such that an end surface (in an axial direction) of the cutaway member 102 of the seal 100 is aligned with the end surface (in the axial direction) of the electrical wire W.

As shown in FIG. 13B, a pair of upper and lower cutting blades 103 are pressed against the boundary between the waterproofing member 101 and the cutaway member 102 to cut and remove the cutaway member 102 together with the cover W2 of the electrical wire W. As shown in FIG. 13C, due to the removal of the cutaway member 102 and the cover W2, the core wire W1 is exposed at the end portion. In this state, the end surface (in the axial direction) of the waterproofing member 101 of the seal 100 is positioned in the vicinity of the end surface (in the axial direction) of the remainder of the cover W2 of the electrical wire W.

A core wire barrel of a metal contact (not shown) is crimped to the exposed core wire W1 of the electrical wire W. An insulating barrel of the contact (not shown) is crimped to the cover W2 of the electrical wire W together with the waterproofing member 101. Because the end surface (in the axial direction) of the waterproofing member 101 is positioned in the vicinity of the end surface (in the axial direction) of the remainder of the cover W2 of the electrical wire W, the insulating barrel can easily be crimped thereto.

The following problems have been encountered in this conventional electrical wire stripping method. Specifically, in the electrical wire stripping method shown in FIGS. 13A-13C, when the cover W2 is cut by the upper and lower cutting blades 103, the boundary between the waterproofing member 101 and the cutaway member 102 of the seal 100 is also cut. The cover W2 therefore can not be cut smoothly due to the waterproofing member 101 and the cutaway member 102 being in the way. As a result, positional deviation between the end surface (in the axial direction) of the waterproofing member 101 and the end surface (in the axial direction) of the remainder of the cover W2 can occur. Additionally, it is necessary to position the seal 100 at the end portion of the electrical wire W for the purpose of crimping the contact (not shown) following the stripping of the electrical wire W. If the seal 100 is positioned at the end portion of the electrical wire W prior to the stripping of the electrical wire W, however, the seal 100 interferes with the cutting blades 103 during the stripping of the electrical wire W, particularly in applications where the contact (not shown) and the electrical wire W have a reduced size.

### BRIEF SUMMARY OF THE INVENTION

It is therefore an object of the present invention to provide an electrical wire stripping method in which the cutting of the cover of the electrical wire can be smoothly performed without any interference from the seal, and the location of an end surface (in the axial direction) of the seal can be positioned accurately with respect to the location of an end surface (in the axial direction) of the remainder of the cover of the electrical wire.

This and other objects are achieved by a method of stripping an electrical wire provided with a seal comprising the steps of: positioning the seal on the electrical wire in a position removed a specified distance in an axial direction from a front-end surface of the electrical wire; cutting a cover of the electrical wire by pressing cutting blades against the cover of the electrical wire between the seal and the front-end surface of the electrical wire; removing a cut portion of the cover by moving the cutting blades toward the front-end surface; cutting a core wire of the electrical wire by pressing the cutting blades against the core wire of the electrical wire between the seal and the front-end surface of the electrical wire; and moving the seal in the axial direction toward the front-end surface of the electrical wire to position the seal in the vicinity of a front-end surface of a remainder of the cover.

### BRIEF DESCRIPTION OF THE DRAWINGS

FIG. 1 is a structural diagram of an electrical wire stripping apparatus showing a first step of an electrical wire stripping method according to the invention;

FIG. 2 is a structural diagram of an electrical wire stripping apparatus showing a second step of the electrical wire stripping method;

FIG. 3 is a structural diagram of an electrical wire stripping apparatus showing a third step of the electrical wire stripping method;

FIG. 4 is an enlarged explanatory diagram of essential parts in the third step of the electrical wire stripping method;

FIG. 5 is a structural diagram of an electrical wire stripping apparatus showing a fourth step of the electrical wire stripping method;

FIG. 6 is an enlarged view of a portion of the structural diagram of FIG. 5;

FIG. 7 is a structural diagram of an electrical wire stripping apparatus showing a fifth step of the electrical wire stripping method;

FIG. 8 is an enlarged view of a portion of the structural diagram of FIG. 7;

FIG. 9 is a structural diagram of an electrical wire stripping apparatus showing a sixth step of the electrical wire stripping method;

FIG. 10 is an enlarged view of a portion of the structural diagram of FIG. 9;

FIG. 11 is a structural diagram of an electrical wire stripping apparatus showing a seventh step of the electrical wire stripping method;

FIG. 12 is a structural diagram of an electrical wire stripping apparatus showing an eighth step of the electrical wire stripping method;

FIG. 13A is a sectional view of a wire stripping method according to the prior art showing a seal attached to an end portion of an electrical wire;

FIG. 13B is a sectional view of a wire stripping method according to the prior art showing cutting blades cutting a cutaway member of the seal and a cover of the electrical wire; and

FIG. 13C is a sectional view of a wire stripping method according to the prior art showing the cutaway member of the seal and the cover of the electrical wire removed.

### DETAILED DESCRIPTION OF THE INVENTION

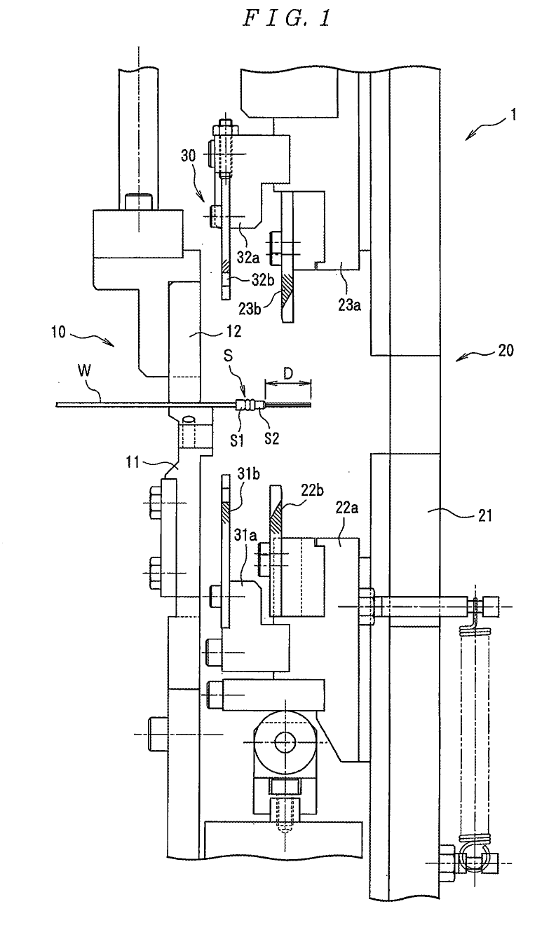

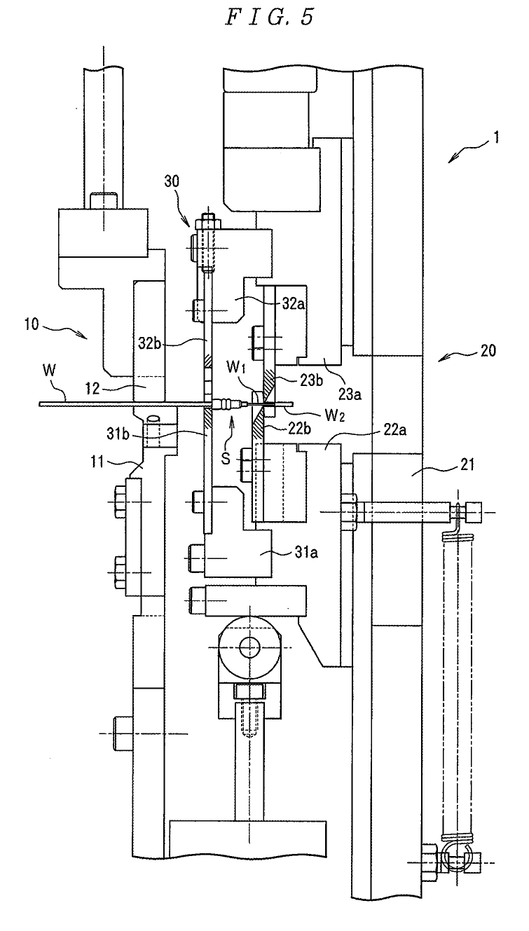

FIGS. 1-12 show an electrical wire stripping apparatus 1 for stripping an electrical wire W. As shown in FIG. 1, the electrical wire stripping apparatus 1 comprises an electrical wire holder 10, a cutting and removing member 20, and a seal positioning member 30. As shown in FIG. 5, the electrical wire W comprises a core wire W1 and a cover W2. As shown in FIG. 1, a seal S is temporarily attached to the electrical wire W. The seal S includes a waterproofing member S1 and a crimping member S2. The seal S may be, for example, a rubber stopper.

As shown in FIG. 1, the electrical wire holder 10 comprises a supporting member 11 and an electrical wire pressing member 12 that is arranged substantially above the supporting member 11. The electrical wire pressing member 12 is constructed so as to be raised and lowered with respect to the supporting member 11. The supporting member 11 supports the electrical wire W from below. The electrical wire pressing member 12 presses the electrical wire W from above as the electrical wire W is carried on the supporting member 11.

The cutting and removing member 20 comprises a base 21. The base 21 is constructed such that the base 21 can move toward and away from the electrical wire holder 10. The direction in which the base 21 moves toward the electrical wire holder 10 is referred to as the rearward direction, while the direction in which this base 21 moves away from the electrical wire holder 10 is referred to as the forward direction. The base 21 comprises a lower supporting member 22a and an upper supporting member 23a. The lower supporting member 22a includes a lower cutting blade 22b and the upper supporting member 23a includes an upper cutting blade 23b that cooperate to cut and remove the cover W2 and the core wire W1 of the electrical wire W. The lower supporting member 22a is attached to the base 21 such that the lower supporting member 22a can move upward and downward to raise and lower the lower cutting blade 22b beneath the electrical wire W held by the electrical wire holder 10. The upper supporting member 23a is attached to the base 21 such that the upper supporting member 23a can move upward and downward to raise and lower the upper cutting blade 23b above the electrical wire W held by the electrical wire holder 10. Since the upper cutting blade 23b and lower cutting blade 22b are respectively provided on the upper supporting member 23a and lower supporting member 22a, the upper and lower cutting blades 23b, 22b move in a forward direction along with the base 21 when the base 21 moves forward, and the upper and lower cutting blades 23b, 22b move in the rearward direction along with the base 21 when the base 21 moves rearward.

The seal positioning member 30 comprises a lower support member 31a and an upper support member 31b. The lower and upper support members 31a, 31b are provided with lower and upper positioning members 31b, 32b, respectively. The lower support member 31a is attached to the lower supporting member 22a of the cutting and removing member 20, and the upper supporting member 32a is attached to the upper supporting member 23a of the cutting and removing member 20. As a result, the lower positioning member 31b can be raised and lowered simultaneously with the lower cutting blade 22b below the electrical wire W that is held by the electrical wire holder 10, and the upper positioning member 32b can be raised and lowered simultaneously with the upper cutting blade 23b above the electrical wire W that is held by the electrical wire holder 10. The upper and lower positioning members 32b, 31b move in the forward direction along with the base 21 when the base 21 moves forward and move in the rearward direction along with the base 21 when the base 21 moves rearward. The seal S, which is temporarily attached to the electrical wire W, is caused to move forward as a result of the combined movement of the upper and lower positioning members 32b, 31b to position the seal S.

A method for stripping the electrical wire W using the electrical wire stripping apparatus 1 will now be described with reference to FIGS. 1-12. As shown in FIG. 1, the seal S is temporarily attached to the electrical wire W so that a front-end surface of the seal S is located in a position that is removed from a front-end surface (in an axial direction) of the electrical wire W by a specified distance D. The electrical wire W, which is provided with the seal S, is positioned on the supporting member 11. The electrical wire pressing member 12 is lowered to press the electrical wire W from above, to hold the electrical wire W in position.

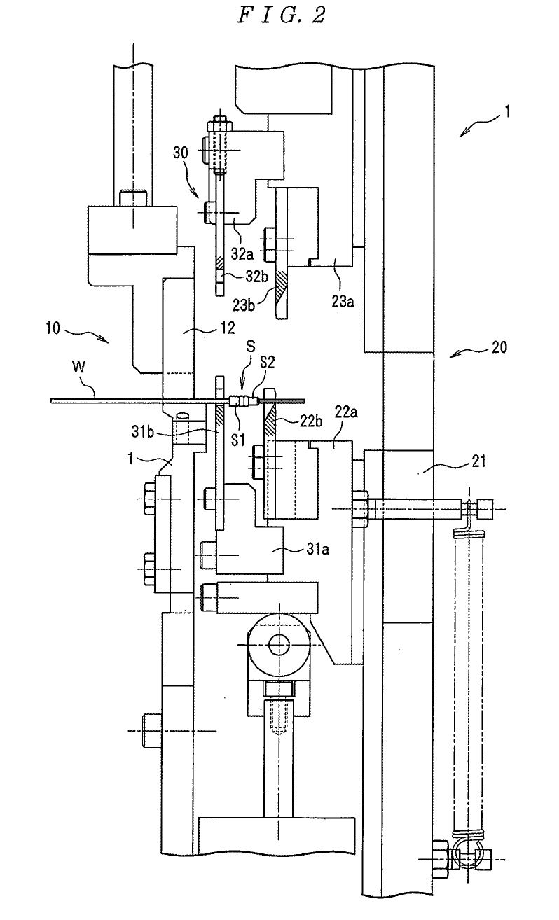

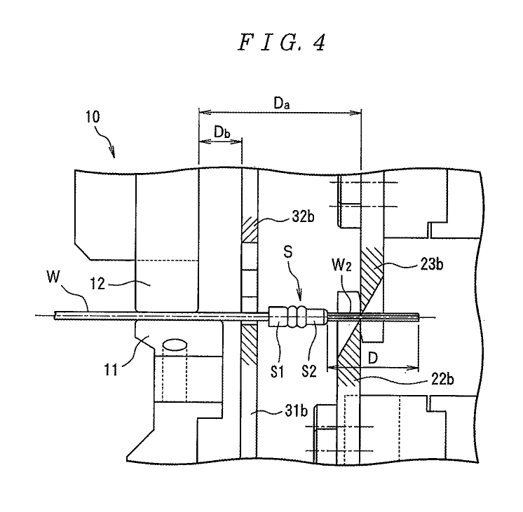

As shown in FIG. 2, the lower cutting blade 22b and lower positioning member 31b are raised until the lower cutting blade 22b presses the cover W2 of the electrical wire W from below and the lower positioning member 31b supports the cover W2 of the electrical wire W from below. The position of the lower cutting blade 22b in the forward-rearward direction is between the seal S and the front-end surface of the electrical wire W. A front-end surface of the electrical wire pressing member 12 and a contact point of the lower cutting blade 22b with the cover W2 of the electrical wire W are positioned at a distance Da, as shown in FIG. 4. The lower positioning member 31b is positioned to a rear of the seal S in the forward-rearward direction. The front-end surface of the electrical wire pressing member 12 and a rear-end surface of the lower positioning member 31b are positioned at a distance Db.

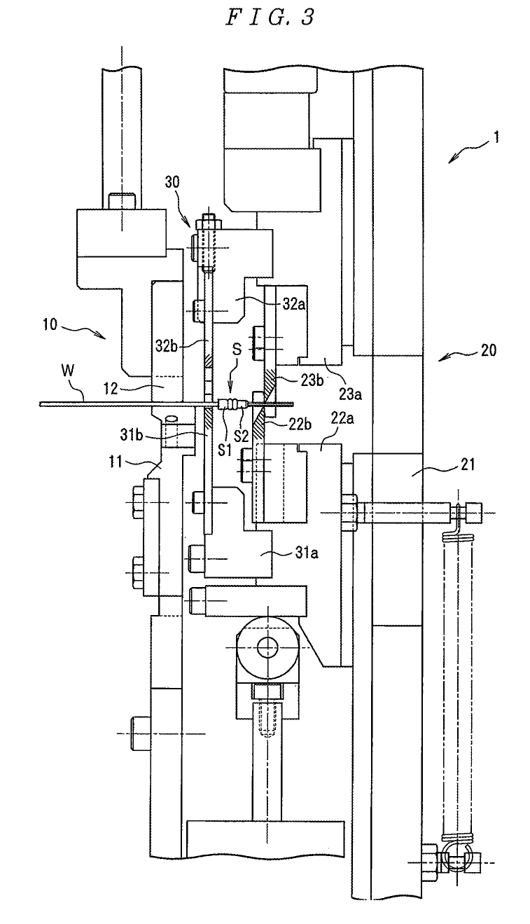

As shown in FIG. 3, the upper cutting blade 23b and upper positioning member 32b are lowered until the upper cutting blade 23b presses the cover W2 of the electrical wire W from above and the upper positioning member 32b presses the cover W2 of the electrical wire W from above. The position of the upper cutting blade 23b in the forward-rearward direction is between the seal S and the front-end surface of the electrical wire W. The front-end surface of the electrical wire pressing member 12 and a contact point of the upper cutting blade 23b with the cover W2 of the electrical wire W are positioned at the distance Da, as shown in FIG. 4. The upper positioning member 32b is positioned to the rear of the seal S in the forward-rearward direction. The front-end surface of the electrical wire pressing member 12 and the rear-end surface of the upper positioning member 32b is positioned at the distance Db. When the upper cutting blade 23b presses the cover W2 of the electrical wire W from above, the upper cutting blade 23b cuts the cover W2 of the electrical wire W in cooperation with the lower cutting blade 22b.

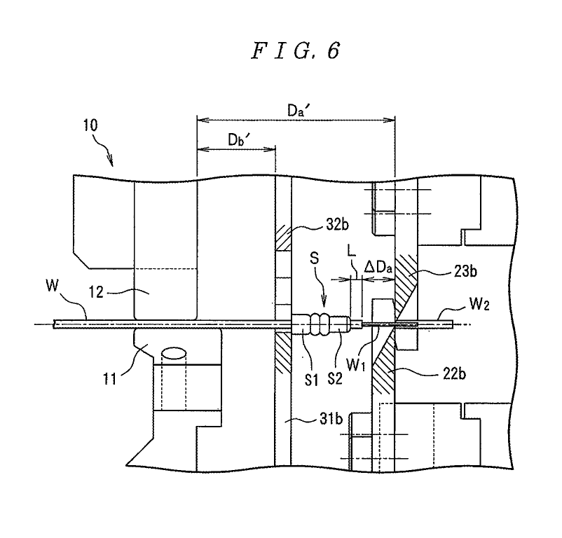

As shown in FIG. 5, the lower and upper cutting blades 22b, 23b are caused to move forward such that the front-end surface of the electrical wire pressing member 12 and the contact point of the lower and upper cutting blades 22b, 23b with the cover W2 of the electrical wire W is a distance Da′, as shown in FIG. 6. As a result, the cover W2, which has been cut, moves forward by a distance ADa, which is the difference between the distance Da′ and the distance Da, and is thus removed. The lower and upper positioning members 31b, 32b also move forward along with the lower and upper cutting blades 22b, 23b such that the front-end surface of the electrical wire pressing member 12 and the rear-end surfaces of the lower and upper positioning members 31b, 32b are positioned at a distance Db′. As a result, the rear-end surface of the waterproofing member S1 of the seal S is pressed forward, so that the seal S moves to a position where the front-end surface (in the axial direction) of the crimping member S2 of the seal S and the front-end surface (in the axial direction) of the remainder of the cover W2 of the electrical wire W is positioned at a distance L.

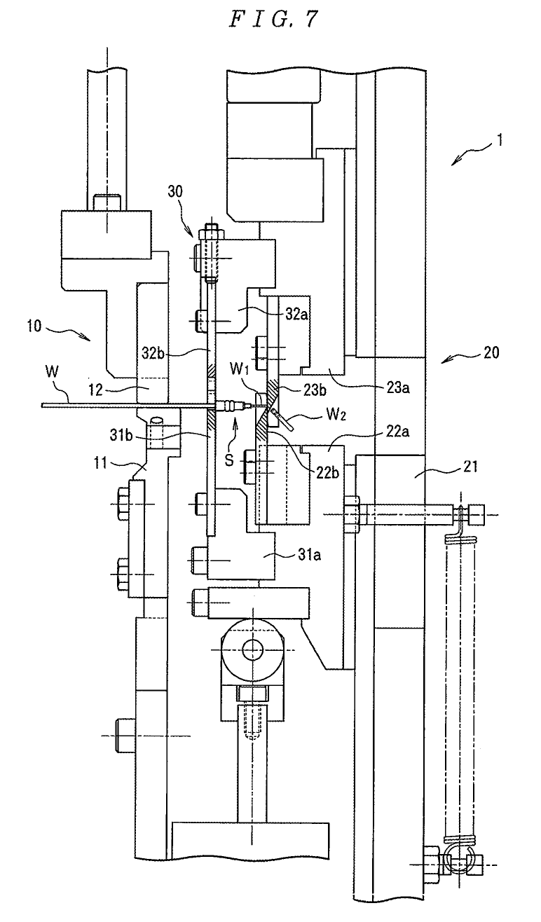

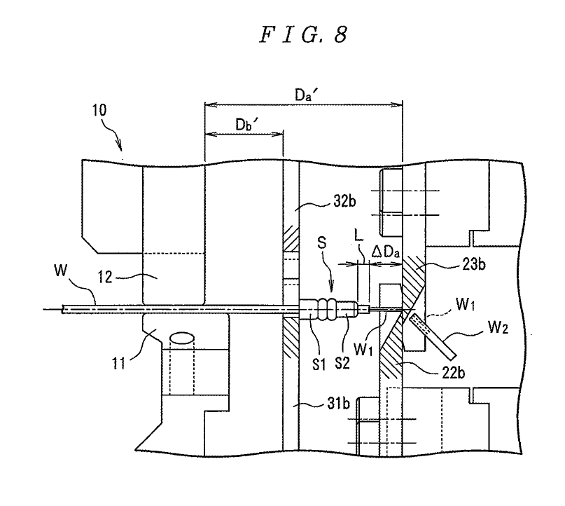

As shown in FIGS. 7-8, in this position, the upper cutting blade 23b is lowered further to cut and remove the core wire W1. The length between the front-end surface of the remaining core wire W1 and the front-end surface of the remainder of the cover W2 is the same as the distance ΔDa described above.

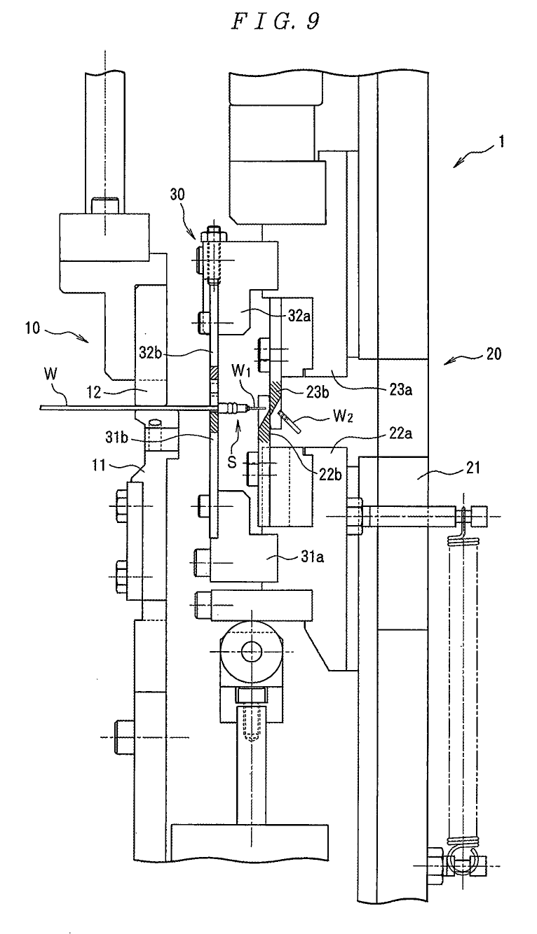

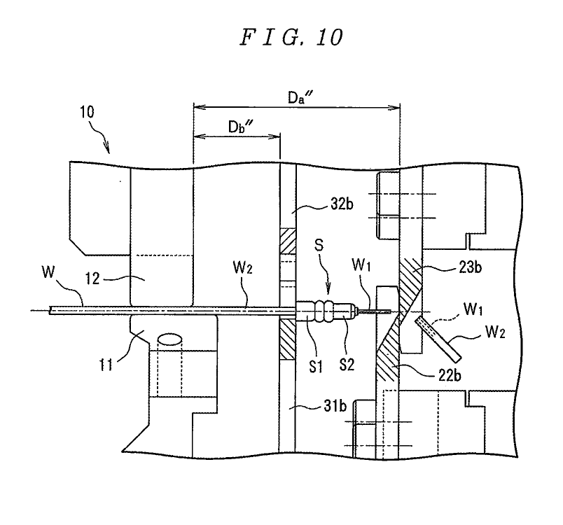

As shown in FIGS. 9-10, the lower and upper positioning members 31b, 32b are moved forward such that the front-end surface of the electrical wire pressing member 12 and the rear-end surfaces of the lower and upper positioning members 31b, 32b are positioned at a distance Db″ to position the front-end surface (in the axial direction) of the crimping member S2 of the seal S at the front-end surface (in the axial direction) of the remainder of the cover W2. At the same time, the lower and upper cutting blades 22b, 23b also move forward such that the front-end surface of the electrical wire pressing member 12 and the contact point of the lower cutting blade 22b with the upper cutting blade 23b are positioned at a distance Da″.

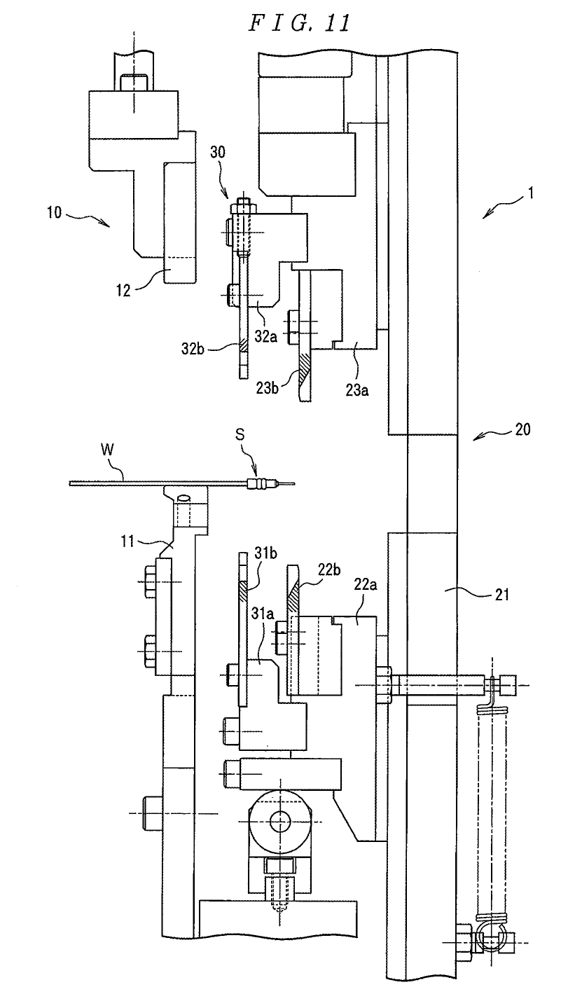

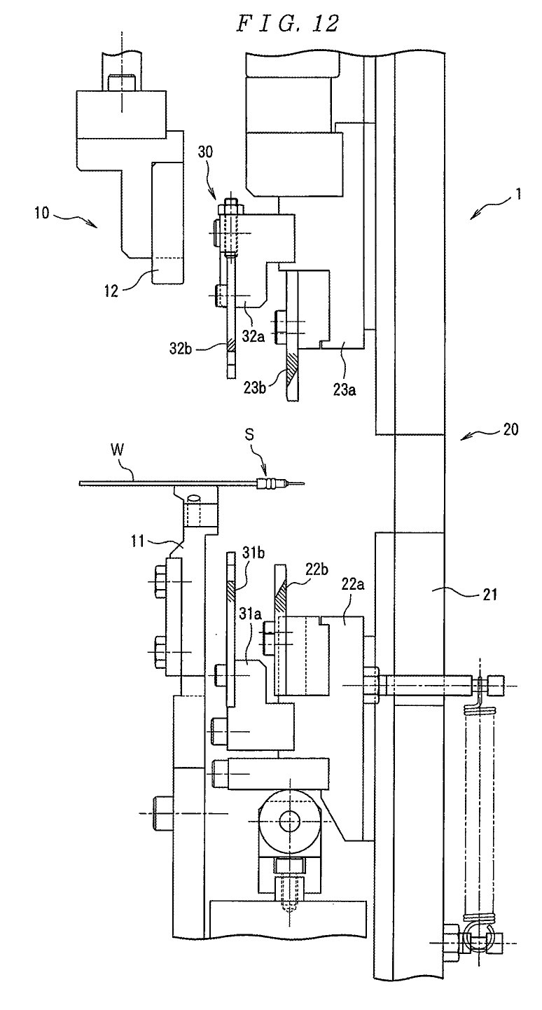

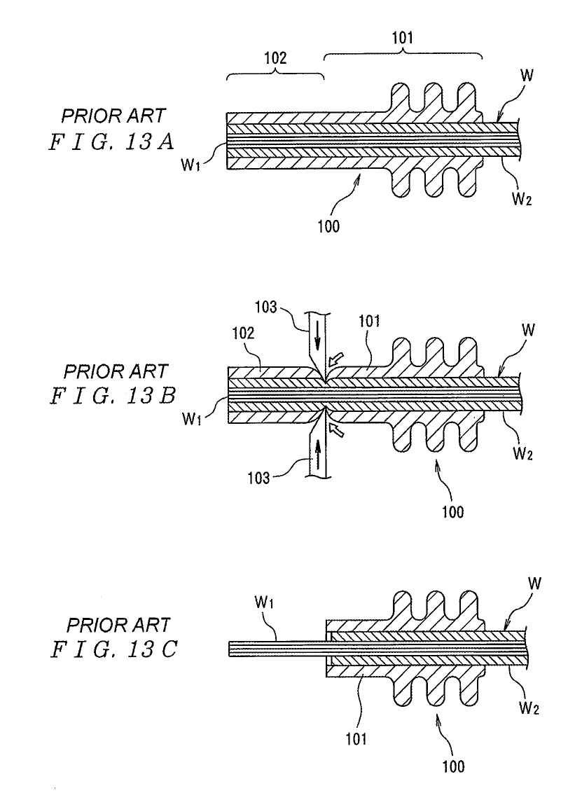

As shown in FIG. 11, the lower cutting blade 22b and lower positioning member 31b are lowered, while the electrical wire pressing member 12, upper cutting blade 23b, and upper positioning member 32b are raised. As shown in FIG. 12, the lower cutting blade 22b, lower positioning member 31b, upper cutting blade 23b, and upper positioning member 32b are then retracted to their initial positions. As a result, the stripping of the electrical wire W to which the seal S is attached is completed.

After the electrical wire W has been stripped, a core wire barrel of a metal contact (not shown) may be crimped to the core wire W1 of the electrical wire W. An insulating barrel of the contact (not shown) may be crimped to the cover W2 of the electrical wire W together with the crimping member S2 of the seal S.

In the electrical wire stripping method described above, the seal S is temporarily attached to the electrical wire W so that the front-end surface of the seal S is located in a position that is removed from the front-end surface (in the axial direction) of the electrical wire W by the distance D. Further, the front-end surface of the electrical wire pressing member 12 and the contact point of the lower and upper cutting blades 22b, 23b with the cover W2 of the electrical wire W are positioned at the distance Da, the cover W2 of the electrical wire W is cut by the lower and upper cutting blades 22b, 23b, and the lower and upper cutting blades 22b, 23b are caused to move forward to remove the cut cover W2. As a result, the cutting and removing of the cover W2 of the electrical wire W can be performed smoothly and without any interference from the seal S. Furthermore, even in cases where the diameter of the electrical wire W and/or the size of the contact (not shown) that is connected to the electrical wire W are reduced, interference from the seal S with the lower cutting blade 22b and upper cuffing blade 23b is eliminated.

The upper cutting blade 23b is lowered further in the moved position in the axial direction, so that the core wire W1 is cut by the upper cutting blade 23b and lower cutting blade 22b, and the cut core wire W1 is removed. The seal S is then caused to move forward so that the front-end surface (in the axial direction) of the crimping member S2 of the seal S is positioned at the front-end surface (in the axial direction) of the remainder of the cover W2. Accordingly, the unnecessary core wire W1 of the electrical wire W can be removed appropriately and smoothly, and the location of the front-end surface (in the axial direction) of the seal S can be positioned accurately with respect to the location of the front-end surface (in the axial direction) of the remainder of the cover W2 of the electrical wire W.

The foregoing illustrates some of the possibilities for practicing the invention. Many other embodiments are possible within the scope and spirit of the invention. For example, instead of performing the positioning of the seal S with the two-step operation described above with reference to FIGS. 5 and 9, it would also be possible to position the front-end surface (in the axial direction) of the crimping member S2 of the seal S at the front-end surface (in the axial direction) of the remainder of the cover W2 in the step shown in FIG. 9. Furthermore, it is not absolutely necessary to position the front-end surface (in the axial direction) of the crimping member S2 of the seal S at the front-end surface (in the axial direction) of the remainder of the cover W2. It would be sufficient if the front-end surface (in the axial direction) of the seal S is positioned is in a vicinity of the front-end surface (in the axial direction) of the remainder of the cover W2. It is, therefore, intended that the foregoing description be regarded as illustrative rather than limiting, and that the scope of the invention is given by the appended claims together with their full range of equivalents.

What is claimed is:

1. A method for stripping an electrical wire provided with a seal, comprising the steps of:
positioning the seal on the electrical wire in a position removed a specified distance in an axial direction from a front-end surface of the electrical wire;
cutting a cover of the electrical wire by pressing cutting blades against the cover of the electrical wire between the seal and the front-end surface of the electrical wire;
removing a cut portion of the cover by moving the cutting blades toward the front-end surface;
cutting a core wire of the electrical wire by pressing the cutting blades against the core wire of the electrical wire between the seal and the front-end surface of the electrical wire; and
moving the seal in the axial direction toward the front-end surface of the electrical wire to position the seal in the vicinity of a front-end surface of a remainder of the cover.

2. The method of claim 1, wherein the core wire is cut after moving the cutting blades toward the front-end surface.

3. The method of claim 1, wherein the seal is moved after the cut portion of the cover is removed and before the core wire is cut.

4. The method of claim 1, wherein the seal is moved after the core wire is cut.

5. The method of claim 1, wherein the seal is moved after the cover is cut and after the core wire is cut.

6. The method of claim 1, wherein the seal includes a crimping member and a waterproofing member, the crimping member being positioned closer to the front-end surface of the electrical wire than the waterproofing member.

7. The method of claim 1, further comprising the step of removing a cut portion of the core wire.
